(19) United States
(12) Patent Application Publication
(10) Pub. No.: US 2012/0323729 A1
(43) Pub. Date: Dec. 20, 2012

(54) CONSUMABLES INVENTORY MANAGER

(75) Inventor: Eric V. Kline, Rochester, MN (US)

(73) Assignee: INTERNATIONAL BUSINESS MACHINES CORPORATION, Armonk, NY (US)

(21) Appl. No.: 13/164,044

(22) Filed: Jun. 20, 2011

(51) Int. Cl. G06Q 30/00

(52) U.S. Cl. 705/26.8

(57) ABSTRACT

An apparatus, system, and method for a consumables inventory manager. One embodiment of the method includes maintaining a consumables inventory by monitoring acquisition and consumption of a plurality of consumables. The method may also include storing a plurality of consumption options. Each consumption option may specify a use for one or more particular consumables of the plurality of consumables. The method may also include producing a plurality of current consumption options for consumption within a predetermined time period. The method may also include selecting a particular consumption option as a particular current consumption option based on a cost of consumables in the particular consumption option.

### FIELD

The subject matter disclosed herein relates to consumables and more particularly relates to a consumables inventory manager.

### BACKGROUND

The management of consumables can be difficult, typically calling for maintaining a record of consumables on hand, consumables consumed, and what consumables to acquire. As the rate of consumption increases, so does the complexity of consumable management.

For example, a household may spend a significant amount of time managing its food consumables. Menu planning, shopping lists, food inventory recording, and the like, can typically take at least one household member several hours each week. Often, many households neglect these tasks, instead, eating more often at restaurants or eating pre-packaged meals.

### BRIEF SUMMARY

From the foregoing discussion, it should be apparent that a need exists for an apparatus, system, and method for a consumables inventory manager. Beneficially, such an apparatus, system, and method would produce current consumption options, generate acquisition lists, identify additional preferred consumption options, and the like.

The present invention has been developed in response to the present state of the art, and in particular, in response to the problems and needs in the art that have not yet been fully solved by currently available consumables inventory systems. Accordingly, the present invention has been developed to provide an apparatus, system, and method for a consumables inventory manager that overcomes many or all of the above-discussed shortcomings in the art.

In one embodiment, the method for a consumables inventory manager includes maintaining a consumables inventory by monitoring acquisition and consumption of a plurality of consumables. The method may also include storing a plurality of consumption options. Each consumption option may specify a use for one or more particular consumables of the plurality of consumables. The method may also include producing a plurality of current consumption options for consumption within a predetermined time period. The method may also include selecting a particular consumption option as a particular current consumption option based on a cost of consumables in the particular consumption option.

The apparatus for a consumables inventory manager is provided with a plurality of modules configured to functionally execute the steps of maintaining a consumables inventory, storing a plurality of consumption options, producing a plurality of current consumption options, and selecting a particular consumption option as a particular current consumption option. These modules in the described embodiments include an inventory module, a storage module and a production module.

In one embodiment, the inventory module maintains a consumables inventory by monitoring acquisition and consumption of a plurality of consumables. In one embodiment, the storage module stores a plurality of consumption options and each consumption option may specify a use for one or more particular consumables of the plurality of consumables. In one embodiment, the production module produces a plurality of current consumption options for consumption within a predetermined time period and selects a particular consumption option as a particular current consumption option based on a cost of consumables in the particular consumption option.

The system for a consumables inventory manager may be embodied as a processor and a memory that stores modules for execution by the processor. The memory includes, in one embodiment, an inventory module, a storage module, and a production module.

In one embodiment, the inventory module maintains a consumables inventory by monitoring acquisition and consumption of a plurality of consumables. In one embodiment, the storage module stores a plurality of consumption options and each consumption option may specify a use for one or more particular consumables of the plurality of consumables. In one embodiment, the production module produces a plurality of current consumption options for consumption within a predetermined time period and selects a particular consumption option as a particular current consumption option based on a cost of consumables in the particular consumption option.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating an embodiment of a system for a consumables inventory manager in accordance with the present invention;

FIG. 2A is a schematic block diagram illustrating one embodiment of a system for a consumables inventory manager in accordance with the present invention;

FIG. 2B is a schematic block diagram illustrating another embodiment of a system for a consumables inventory manager in accordance with the present invention;

FIG. 3 is a schematic block diagram illustrating one embodiment of a inventory manager apparatus in accordance with the present invention;

FIG. 4 is a detailed schematic block diagram illustrating another embodiment of a inventory manager apparatus in accordance with the present invention;

FIG. 5 is a schematic flow chart diagram illustrating one embodiment of a method for a consumables inventory manager in accordance with the present invention;

FIG. 6 is a detailed schematic flow chart diagram illustrating another embodiment of a method for a consumables inventory manager in accordance with the present invention; and

FIG. 7 is a schematic flow chart diagram illustrating one embodiment of a method for identifying additional preferred consumption options in accordance with the present invention.

### DETAILED DESCRIPTION OF THE INVENTION

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

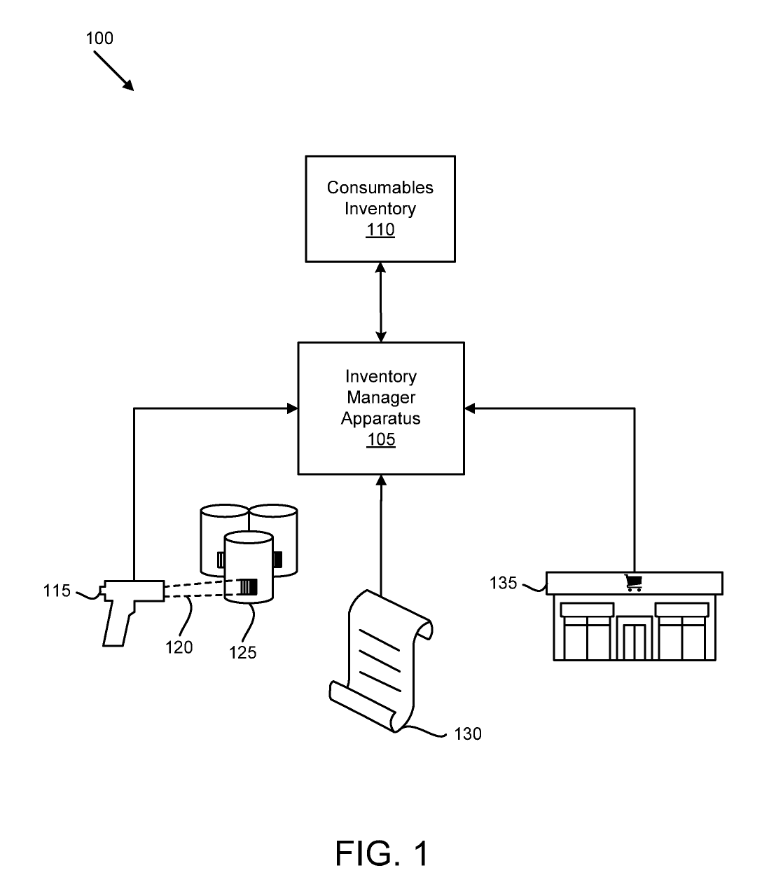

FIG. 1 depicts an embodiment of a system 100 for a consumables inventory manager in accordance with the present invention. The system 100 includes an inventory manager apparatus 105 and a consumables inventory 110. Furthermore, the system 100 may also include a scanner 115 for scanning 120 consumables 125. Consumables may include resources that are depleted when used and may include food items, cleaning supplies, paper products, office supplies, and the like. Due to the frequency of the acquisition and consumption cycle of many consumables, managing consumables, including acquisition, consumption, and uses for the consumables, may be a difficult task.

Therefore, the inventory manager apparatus 105 may maintain and/or manage a consumables inventory 110 for one or more users. The consumables inventory 110 may include a record of consumables including existing consumables, archived consumables, and/or the like. The consumables inventory 110 may be embodied as a database and/or other form of electronic storage in communication with the inventory manager apparatus 105, integrated with the inventory manager apparatus 105, and/or the like. The consumables inventory 110 may store data entries for consumables. Such data entries may include information on consumable name, type, quantity, price, expiration date, and/or any other suitable information.

In one embodiment, the inventory manager apparatus 105 maintains the consumables inventory 110 by monitoring acquisition and consumption of a plurality of consumables. The inventory manager apparatus 105 may add and remove consumables from the consumables inventory 110 by way of manual user input, automatic upload, automatic consumable increment and/or decrement, and the like. Specifically, in one embodiment, the inventory manager apparatus 105 may add or remove consumables from the consumables inventory 110 through a scanner 115, such as a handheld barcode scanner, that scans 120 consumable identifiers (e.g. barcodes). The inventory manager apparatus 105 may add or remove a particular consumable from the consumables inventory 110 in response to the scanner 115 scanning 120 the identifier for the particular consumable 125. For example, a user may, after purchasing a can of food, scan 120 the can of food to add it to the consumables inventory 110. Additionally, the inventory manager apparatus 105 may, upon selection of an item for consumption by the user, remove or decrement the consumable in the selected quantity from the consumables inventory 110. The user, upon actually consuming the item of food, may also scan 120 the item of food to indicate that the consumable should be removed and/or decremented in quantity from the consumables inventory 110.

As stated above, a user may manually specify consumables to be added, incremented, removed, or decremented to the consumables inventory 110 and/or may enter a receipt 130 (e.g. by optically scanning the receipt) showing a record of consumable acquisition. In certain embodiments, the inventory manager apparatus 105 may receive consumable information from a consumables source such as a store 135 (e.g. by communicating with a store's 135 server, by data uploaded to a user's portable memory then downloaded by the inventory manager apparatus 105, and/or the like).

In addition, the inventory manager apparatus 105 may store, generate, and/or produce consumption options specifying a use for the consumables. Such consumption options may include recipes, calling for certain consumables in various amounts. The inventory manager apparatus 105 may select consumption options to recommend and/or present to a user based on cost of consumables in the consumption options, based on preferred consumption options (e.g. a user's “favorites”), consumption options predicted as potential favorites, guest preferences, and the like. The inventory manager apparatus 105 may also generate acquisition lists based on consumption and/or consumption options, allow a user to view and search the consumables inventory 110 according to a user-selected class, and the like.

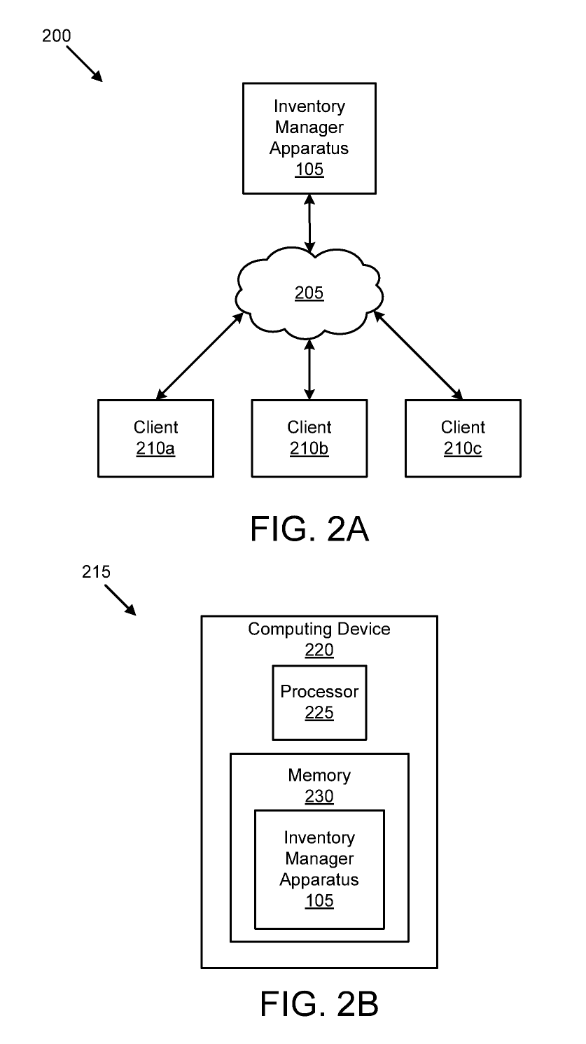

Referring to FIG. 2A, depicting one embodiment of a system 200 for a consumables inventory, one or more users may interface with the inventory manager apparatus 105 through one or more clients 210a, 210b, 210c and the inventory manager apparatus 105 may communicate with the one or more clients 210a, 210b, 210c, through a communication medium 205. As described below in relation to FIG. 2B, all or a portion of the inventory manager apparatus 105 may reside on one or more computing and/or information handling devices such as personal computers, servers, mainframes, personal desktop assistants (“PDA”s), tablet computers, Smartphones, and the like. Furthermore, all or a portion of the inventory manager apparatus 105 may be implemented as logic hardware, software or a combination of logic hardware and software.

In one embodiment, the communication medium 205 may comprise a communications network such as the Internet, a Local Area Network (“LAN”), multiple LANs communicating over the internet, or any other similar communications network. For example, the inventory manager apparatus 105 may reside on a web server and various users may access the inventory manager apparatus 105 through the web server over the internet 205. In one embodiment, the communication medium 205 comprises a system bus, such as a peripheral component interconnect express (“PCI-e”) bus, a Serial Advanced Technology Attachment (“serial ATA”) bus, or the like.

A client 210a may communicate with the inventory manager apparatus 105 through the communication medium 205. In one embodiment, the client 210a may be embodied as a desktop computer, a portable computer, a server, a mainframe computer, a handheld computing device, a touch device, a PDA, a table computer, an e-Book reader, a mobile phone, a Smartphone, and the like. In one embodiment, the client 210a may also include and/or is embodied as a software application.

FIG. 2B depicts another embodiment of a system 215 for a consumables inventory in accordance with the present invention. The system 215 includes a computing device 220 with at least one processor 225 and a memory 230. Furthermore, in the depicted embodiment, the memory 230 includes the inventory manager apparatus 105. The computing device 220 may include, but is not limited to, a personal computer, a server, a personal desktop assistant (“PDA”), a tablet computer, a Smartphone, and the like. The memory 230 may store computer readable programs and the processor 225 may execute the computer readable programs as known to those skilled in the art.

As depicted, in one embodiment, all or a portion of the inventory manager apparatus 105 may be stored on the memory 230 and executed by the processor 225. In addition, as stated above, in some embodiments, all or a portion of the inventory manager apparatus 105 may be implemented as logic hardware. Furthermore, although in the depicted embodiment, the inventory manager apparatus 105 resides in the computing device 220, in other embodiments, all or a portion of the inventory manager apparatus 105 may reside in an external device in communication with the computing device 220, or may reside in a plurality of computing devices 220. In one embodiment, a scanner, such as the scanner 115 depicted in FIG. 1, may be in communication with the processor 225.

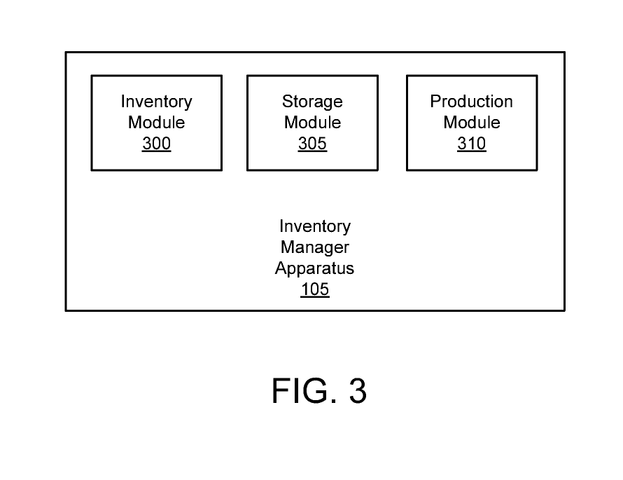

FIG. 3 depicts one embodiment of an inventory manager apparatus 105 in accordance with the present invention. The inventory manager apparatus 105 may be one embodiment of the inventory manager apparatus 105 depicted in FIGS. 1, 2A, and 2B. The inventory manager apparatus 105 includes one or more of an inventory module 300, a storage module 305, and a production module 310.

The inventory module 300, in one embodiment, maintains a consumables inventory 110 having a plurality of consumables. In one embodiment, at least a portion of the plurality of consumables comprises food. Likewise, the consumables inventory 110 may be a household consumables inventory 110 with household consumables including cleaning products, paper products, and other household items. Of course, any suitable consumable may be included in the consumables inventory including office consumables such as paper and toner, health care consumables such as medications and medical supplies, and the like.

In one embodiment, maintaining the consumables inventory 110 includes monitoring acquisition and consumption of the plurality of consumables. Furthermore, the inventory module 300 may monitor existing consumables plus additional acquisitions minus consumption of previously acquired consumables to maintain the consumables inventory 110. The inventory module 300 may store records of consumables in a database, flat file, and/or other suitable form of electronic storage. As stated above, the consumables inventory 110 may store entries for consumables including information on consumable name, type, quantity, price, expiration date, and/or other suitable information. In one embodiment, the consumables inventory 110 includes current consumables and archived consumables, maintaining a record of consumable acquisition and consumption.

In one embodiment, the inventory module 300 may establish an initial inventory baseline with an initial amount of consumables. Specifically, a user may populate the consumables inventory 110 with an initial amount of consumables during a set-up or configuration phase. The inventory module 300 may then monitor consumption and acquisition of consumables, incrementing and decrementing consumables from the initial inventory baseline.

The inventory module 300 may add consumables (for the initial inventory baseline and subsequent additions) by manual user entry, by a user scanning a paper receipt with optical character recognition (“OCR”), by the user scanning a consumable with a barcode scanner as described above, from a consumables source (e.g. a store) providing access to digital purchase data by download into the user's portable memory that the user can synchronize with the inventory module 300, by receiving digital purchase data directly from a store database, from a third party database, and/or the like. The inventory module 300 may, in certain embodiments, automatically add consumables to the consumables inventory 110 that are regularly acquired (e.g. automatically add two gallons of milk every Friday when the milkman is scheduled to deliver).

The inventory module 300 may also remove consumables from the consumables inventory 110 by manual user entry, a user scanning a consumable identifier (e.g. a barcode) when the consumable is consumed, assigning a particular consumable to a consumption option and decrementing the consumables inventory 110 when the consumption option is consumed by the user as described below, and the like.

The storage module 305, in one embodiment, stores a plurality of consumption options. As stated above, a consumption option may specify a use for consumables. Consumption options may specify combinations of consumables, amounts of certain consumables to use, and the like. In one embodiment, a consumption option is a recipe and the storage module 305 stores multiple recipes.

The storage module 305 may store and/or reference consumption options in a database, flat file, other suitable forms of electronic storage, a third-party database, the internet, and/or the like. In one embodiment, the storage module 305 references and/or obtains consumption options from the internet (e.g. the storage module 305 may periodically download consumption options), from manual entry by a user, from a user scanning a consumption option with OCR, and the like.

In one embodiment, the plurality of consumption options stored by the storage module 305 includes preferred consumption options. A preferred consumption option may be identified as a preferred consumption option by one or more users. For example, a user or household may designate a particular recipe as a favorite recipe and the storage module 305 may save the particular recipe as a preferred consumption option. The storage module 305 may also allow one or more users (e.g. in a household) to vote on a particular consumption option and designate the particular consumption option as a preferred consumption option in response to it receiving a predetermined number of votes. The storage module 305 may also automatically designate a consumption option as a preferred consumption option in response to consumption trends (e.g. the particular consumption option is consumed a predetermined number of time or at certain times of year). The storage module 305 may also store adapted consumption options (e.g. with one or more ingredients changed), potential preferred consumption options, and the like as described below.

The production module 310, in one embodiment, produces a plurality of current consumption options. Current consumption options may include consumption options scheduled for consumption within a predetermined time period such as a specific occasion, a day, a week, a month and the like. In one embodiment, the plurality of current consumption options comprises a menu plan. In one embodiment, producing consumption options includes scheduling consumption options for certain time periods and/or recommending or presenting possible consumption options to a user for selection as current consumption options. Producing current consumption options may also include receiving a user selection of consumption options and designating those received consumption options as current consumption options. The production module 310 may allow a user to search or browse consumption options from the storage module 305 by key word, preferred status, consumable ingredient, and the like.

The production module 310 may produce current consumption options based on specified objectives such as health objectives (e.g. the user wants low fat recipes, low carbohydrate recipes, and the like), cost objectives, conservation objectives, guest preferences as described below, preferred consumption options, and the like. For example, the production module 310 may present consumption options based on these objectives to the user for selection as current consumption options, may automatically assign consumption options as current consumption options based on these objectives, and the like.

In one embodiment, producing a plurality of current consumption options further comprises producing a plurality of current consumption options that include consumables being part of a user-selectable class. The user may search for and/or filter consumables based on a particular class (e.g. all consumables with beans) and the production module 310 may present consumption options having consumables of that class. As described below, in some embodiments, the production module 310 may produce the plurality of current consumption options based at least in part on a guest user's consumption preferences and/or consumption restrictions, on cost of consumables, and the like.

In one embodiment, the production module 310 selects a particular consumption option as a particular current consumption option based on a cost of consumables in the particular consumption option. In a further embodiment, the production module 310 selects a particular consumption option having a lower total cost of consumables. The production module 310 may use cost of consumables as a co-factor in selecting current consumption options along with other co-factors such as preferred consumption options, objectives, guest preferences, and the like.

In a further embodiment, selecting a consumption option as a current consumption option includes identifying a discounted consumable available for purchase and identifying a particular consumption option having the discounted consumable. The production module 310 may then select the particular consumption option as a current consumption option. In one embodiment, the production module 310 may identify discounted consumables from a data feed having advertisements and promotions, directly from a store's server, in response to a user entering promotional data, and the like. For example, the production module 310 may poll to seek store sales items for a prescribed date window and build a menu recommendation based on an optimal intersection of sales items, preferred consumption options, objectives, and the like.

Selecting a consumption option as a current consumption option may include automatically assigning a consumption option as a current consumption option, presenting a consumption option to the user as a current consumption option for approval, suggesting or recommending a consumption option to the user, and the like. In one embodiment, the production module 310 assigns a particular consumption option as a particular current consumption option in response to the user selecting the particular consumption option, such as after the production module 310 has presented the particular consumption option as a choice.

Furthermore, the production module 310, in producing, selecting, and/or recommending current consumption options, may also prioritize consumption options based on one or more user-selectable preferences such as user restrictions (e.g. diet and/or medical restrictions), leftover expiration dates as described below, a user's priorities (e.g. saving costs, eating healthy, and the like).

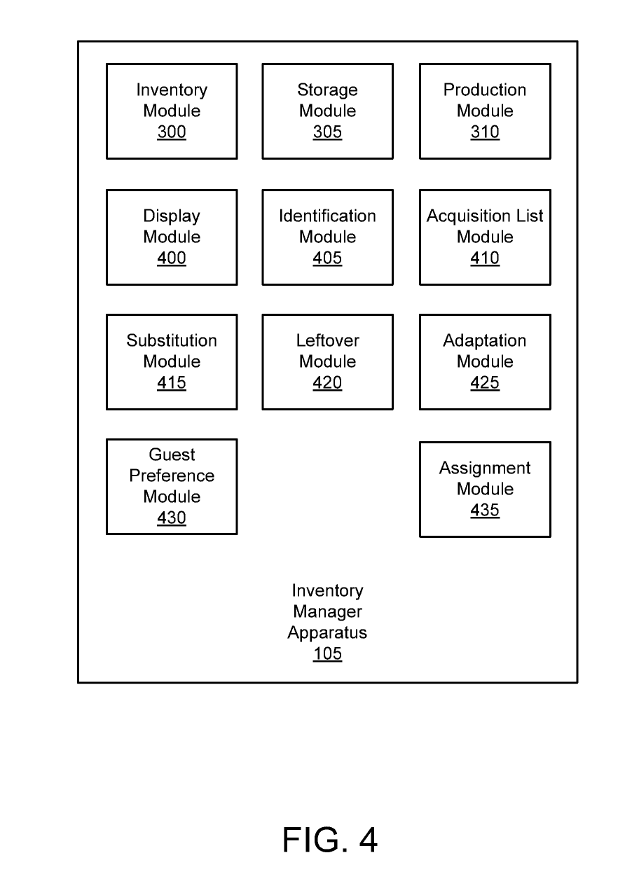

FIG. 4 depicts another embodiment of the inventory manager apparatus 105 in accordance with the present invention. The apparatus 105 includes one or more of the inventory module 300, the storage module 305 and the production module 310, which may be similar to the like-named modules described in relation to FIG. 3. In addition, FIG. 4 includes one or more of a display module 400, an identification module 405, an acquisition list module 410, a substitution module 415, a leftover module 420, an adaptation module 425, a guest preference module 430, and an assignment module 435.

In one embodiment, a user, through the display module 400, may access the consumables inventory 110, stored consumption options, current consumption options, and preferred consumption options. In one embodiment, the display module 400 may display consumables to the user in various formats, according to various filters, and/or by various user designated classes. The display module 400 may allow a user to search the consumables inventory 110 and return results in text, table and/or in icon form. The display module 400 may display consumables with no filter, by user selectable class (e.g. a class of item such as “beans” or vegetables), and the like.

In one embodiment, the display module 400 presents consumption options to a user that the user may select as current consumption options, preferred consumption options and the like. The display module 400 may display a particular consumption option having a discounted consumable. In one embodiment, the display module 400 presents a cost savings of the particular consumption option having the discounted consumable according to the discount.

The display module 400 may include and/or coordinate with a user interface (e.g. a user interface application) to visually display and/or auditorily present information to a user and to accept user input. In one embodiment, the user may select consumption options and consumables through the user interface to perform various operations such as deleting a consumption option, marking a consumption option as a preferred consumption option, incrementing or decrementing a consumable, and the like.

The identification module 405, in one embodiment, identifies one or more additional preferred consumption options, also referred to herein as potential preferred consumption options. These potential preferred consumption options may be identified as consumption options in which a likelihood exists that one or more users would prefer the consumption options. In one embodiment, the identification module 405 may identify potential preferred consumption options out of the plurality of consumption options of the storage module 305 based at least in part on existing preferred consumption options. For example, if a household has several salmon recipes as preferred consumption options, the identification module 405 may identify additional salmon recipes as potential preferred consumption options.

In one embodiment, the identification module 405 identifies potential preferred consumption options by determining common consumables shared by two or more preferred consumption options, prioritizing the common consumables, and searching for consumption options having the one or more common consumables. In one embodiment, the identification module 405 may identify consumption options having a number of common consumables above a predetermined threshold and/or consumption options having higher priority common consumables as potential preferred consumption options.

The identification module 405 may present, as potential (additional) preferred consumption options, consumption options having the common consumables according to priority of the one or more common consumables. The identification module 405 may present the potential preferred consumption options—such as by coordinating with the display module 400—to a user such that the user may select one or more potential preferred consumption options for current consumption options, preferred consumption options, and the like. In one embodiment, the identification module 405 may notify the production module 310 to add the potential preferred consumption options to the current consumption options in response to a user selecting the potential preferred consumption options, or to automatically add the potential preferred consumption options to the current consumption options upon identifying the potential preferred consumption options. In one embodiment, the display module 400 presents potential preferred consumption options according to priority of the one or more common consumables.

The acquisition list module 410, in one embodiment, generates an acquisition list identifying additional consumables for acquisition. The acquisition list may be based on consumption of the plurality of consumables and/or consumable requirements for the plurality of current consumable options. Specifically, in certain embodiments, the acquisition list module 410 generates an acquisition list based on what's been consumed, how much of what consumable the user likes to keep on hand, the current consumption options for a particular period of time and the consumables called for by those current consumption options, and the like.

In one embodiment, the acquisition list module 410 flags a consumable and it's associated consumption options as ‘at risk,’ such as when the consumable is close to running out. The acquisition list module 410 may classify consumption options to be acquired on the acquisition list as optional, recommended, required, and the like. Furthermore, the acquisition list module 410 may also classify an acquisition list as urgent, optional, recommended within a certain number of days, and the like. In one embodiment, a user may filter consumables in creating various acquisition lists (e.g. the user may select all recommended consumables to acquire, urgent consumables, consumables needed within a certain time period, and the like).

The substitution module 415, in one embodiment, recommends a substitution of a first consumable with a second consumable in a particular consumption option to accommodate a user restriction (e.g. a diet or medical condition), a discounted consumable, and/or a user's priorities (e.g. consume leftovers first). In one embodiment, the substitution module 415 notifies the storage module 305 of the consumption option with the substitution and the storage module 305 may store the consumption option with the substitution.

The leftover module 420, in one embodiment, identifies a leftover consumable remaining from a consumption option and assigns an expiration date to the leftover consumable. For example, after a user has consumed a consumption option (e.g. eaten a meal based on a recipe), the user may enter leftover consumables and amounts from the consumption option. In one embodiment, the leftover module 420 maintains the leftover consumables with time and date information. In some embodiments, the leftover module 420 allows the user to prioritize suggested uses of the leftovers based on the user's priorities (e.g. to conserve food, to re-use high cost consumables, to serve leftovers to certain users, and the like). The leftover module 420, in one embodiment, may assign an expiration date based a user-selected expiration date and/or a recommended expiration date based on predetermined factors including conservation, taste, safety, and the like. Furthermore, the leftover module 420 may also interface with the production module 310 to incorporate leftovers into the current consumption options (e.g. assign leftovers from a first meal to be consumed at a second meal). The leftover module 420 may allow the user to select leftover consumption option recommendation strategy based on selectable level of leftover priority (e.g. use leftovers as highest consideration first, use leftovers when they are within two days of expiration, and the like).

The adaptation module 425, in one embodiment, removes a particular consumption option from the current consumption options for a predetermined time period in response to a particular user of a plurality of users being absent for the predetermined time period. For example, if a household member is away on a trip, the adaptation module 425 may remove that household member's preferred consumption option from the current consumption options and/or prevent that meal from being assigned as a current consumption option during the trip. Similarly, the adaptation module 425 may modify the list of preferred consumption options by removing preferred consumption options and/or restrictions of users not present for a specific meal or time period.

The guest preference module 430, in one embodiment, receives a guest user's consumption preferences and/or the guest user's consumption restrictions. The production module 310 may produce the current consumption options based at least in part on the guest user's consumption preferences and/or consumption restrictions received from the guest preference module 430. In one embodiment, a user may transfer preferences and/or restrictions to the guest preference module 430 over the internet, from one user account on the apparatus 105 to another user account on the apparatus 105 in an embodiment in which the apparatus is accessed by multiple clients, by manual user entry, and the like.

The assignment module 435, in one embodiment, assigns a particular consumable to a particular consumable option and decrements an amount of the particular consumable in the consumables inventory 110 in response to the user consuming the particular consumable option to ensure the consumables inventory 110 accounts for designated future consumption. For example, the assignment module 435 may assign six eggs to a particular breakfast and automatically decrement the amount of eggs in the consumables inventory 110 by six when the time passes in which the breakfast was scheduled.

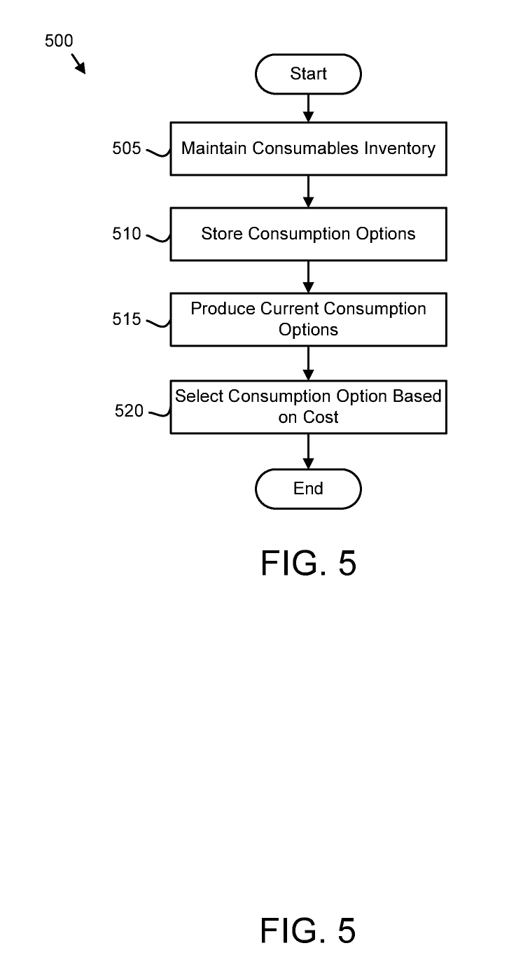

FIG. 5 depicts one embodiment of a method 500 for a consumables inventory manager in accordance with the present invention. The method 500 substantially includes the steps to carry out at least a portion of the functions presented above with respect to the operation of one or more of the described apparatuses and systems of FIGS. 1-4. The method 500 begins and the inventory module 300 maintains 505 a consumables inventory 110 by monitoring acquisition and consumption of a plurality of consumables. The inventory module 300 may be searchable by a user and may, such as through the display module 400, display the consumables inventory 110 according to a user-selectable class of the one or more consumables.

Next, the storage module 305 stores 510 a plurality of consumption options. Each consumption option specifies a use for one or more particular consumables of the plurality of consumables. The production module 310 then produces 515 a plurality of current consumption options for consumption within a predetermined time period. In one embodiment, the production module 310 may produce current consumption options that include consumables being part of a user-selectable class. The production module 310 then selects 520 a particular consumption option as a particular current consumption option based on a cost of consumables in the particular consumption option. Then, the method 500 ends.

In one embodiment, the production module 310 selecting a particular consumption option as a particular current consumption option based on a cost of consumables in the particular consumption option includes the production module 310 identifying a discounted consumable available for purchase, identifying a particular consumption option having the discounted consumable, and presenting the particular consumption option having the discounted consumable to a user and/or presenting a cost savings of the particular consumption option. In this embodiment, the production module 310 may assign the particular consumption option as a particular current consumption option in response to the user selecting the particular consumption option.

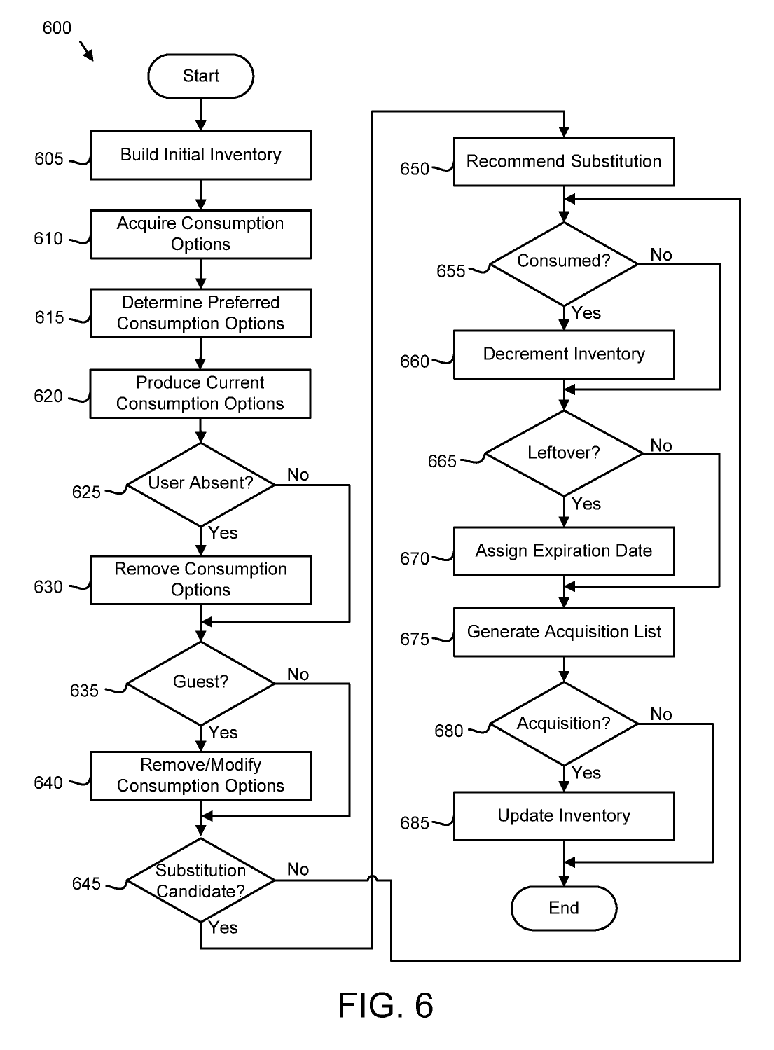

FIG. 6 depicts another embodiment of a method 600 for a consumables inventory manager in accordance with the present invention. The method 600 substantially includes the steps to carry out at least a portion of the functions presented above with respect to the operation of one or more of the described apparatuses and systems of FIGS. 1-4.

The method 600 begins and the inventory module 300 builds 605 an initial inventory of consumables in a consumables inventory 110 through user entry, scanning by a user, communication with a consumables source, and/or the like. Next, the storage module 305 acquires 610 a plurality of consumption options such as through manual user entry, user upload, automatic update over the internet, and/or the like. The storage module 305 then determines 615 one or more preferred consumption options such as through voting or selection by users. The production module 310 produces 620 a plurality of current consumption options for consumption within a predetermined time period.

Next, if the adaptation module 425 determines 625 that a user will be absent for a predetermined time period, the adaptation module 425 removes 630 one or more consumption options preferred by that user from the current consumption options for the predetermined time period. Next, if the guest preference module 430 receives 635 a guest's preferences and/or restrictions, the guest preference module 430 removes 640 one or more current consumption options and/or modifies one or more current consumption options based on the guest's preferences and/or restrictions.

Next, if the substitution module 415 identifies 645 a current consumption option as a candidate for consumable substitution (e.g. the current consumption option includes a consumable that may be substituted with another consumable to permit completion of the recipe with a missing ingredient or to meet a diet restriction), the substitution module 415 recommends 650 a substitution of a first consumable with a second consumable in a particular consumption option. The substitution module 415 may make the substitution automatically or in response to a user approving the substitution. If the inventory module 300 determines 655 that consumables associated with a consumption option were consumed (e.g. a time of a scheduled meal passed or a user indicated that a meal had been consumed), the inventory module 300 decrements 660 the consumables inventory 110 to account for the consumed consumables. The inventory module 300 may automatically decrement the consumables inventory 110 or in response to a user notification.

If the leftover module 420 determines 665 that one or more consumables are leftover, the leftover module 420 assigns 670 an expiration date based on one or more predetermined factors. The acquisition list module 410 generates 675 an acquisition list based on consumption of the consumables related to the consumption option and/or upcoming current consumption options. If the inventory module 300 detects 680 an acquisition such as through a user notification, a scheduled acquisition, or the like, the inventory module 300 updates 685 the consumables inventory 110 to reflect the acquisition and the method 600 ends.

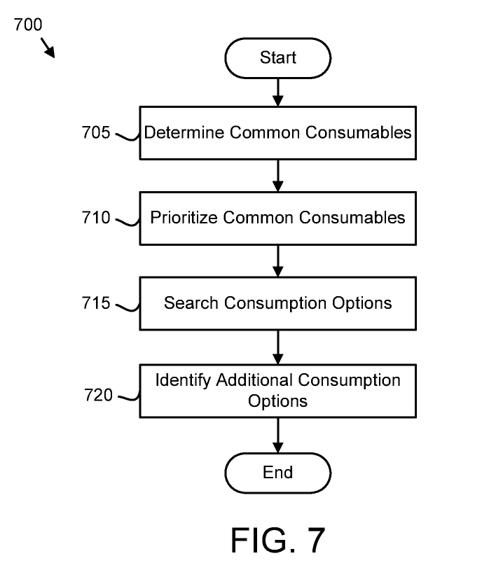

FIG. 7 depicts one embodiment of a method 700 for identifying additional preferred consumption options in accordance with the present invention. The method 700 begins and the identification module 405 determines 705 one or more of common consumables shared by two or more of the preferred consumption options. Next, the identification module 405 prioritizes 710 the one or more common consumables. The identification module 405 then searches 715 for consumption options having the one or more common consumables. Next, the identification module 405 identifies 720, as additional preferred consumption options, one or more consumption options according to priority of the one or more common consumables, and the method 700 ends.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
maintaining a consumables inventory by monitoring acquisition and consumption of a plurality of consumables;
storing a plurality of consumption options, each consumption option specifying a use for one or more particular consumables of the plurality of consumables;
producing a plurality of current consumption options for consumption within a predetermined time period; and
selecting a particular consumption option as a particular current consumption option based on a cost of consumables in the particular consumption option.

2. The method of claim 1, wherein selecting the particular consumption option as the particular current consumption option further comprises identifying a discounted consumable available for purchase and identifying a particular consumption option having the discounted consumable.

3. The method of claim 2, further comprising presenting the particular consumption option having the discounted consumable to a user and assigning the particular consumption option as a particular current consumption option in response to the user selecting the particular consumption option.

4. The method of claim 2, further comprising presenting a cost savings of the particular consumption option having the discounted consumable.

5. The method of claim 1, wherein the plurality of consumption options comprises recipes, at least a portion of the plurality of consumables comprises food, and the plurality of current consumption options comprises a menu plan.

6. The method of claim 1, wherein the plurality of consumption options comprises preferred consumption options identified by a user, the method further comprising identifying one or more additional preferred consumption options out of the plurality of consumption options based at least in part on the preferred consumption options.

7. The method of claim 6, wherein identifying the one or more additional preferred consumption options comprises:
determining one or more of common consumables shared by two or more of the preferred consumption options;
prioritizing the one or more common consumables;
searching for consumption options having the one or more common consumables; and
presenting, as additional preferred consumption options, one or more consumption options according to priority of the one or more common consumables.

8. The method of claim 1, further comprising generating an acquisition list identifying additional consumables for acquisition, the acquisition list based on one or more of consumption of the plurality of consumables and consumable requirements for the plurality of current consumable options.

9. The method of claim 1, further comprising displaying the consumables inventory according to a user-selectable class of the one or more consumables.

10. The method of claim 1, wherein producing a plurality of current consumption options further comprises producing a plurality of current consumption options comprising consumables being part of a user-selectable class.

11. The method of claim 1, further comprising recommending a substitution of a first consumable with a second consumable in a particular consumption option to accommodate one or more of a user restriction and a discounted consumable.

12. The method of claim 1, further comprising identifying a leftover consumable remaining from a consumption option and assigning an expiration date to the leftover consumable based on one or more predetermined factors.

13. The method of claim 1, further comprising receiving one or more of guest user's consumption preferences and consumption restrictions, wherein producing the plurality of current consumption options further comprises producing the plurality of current consumption options based at least in part on one or more of the guest user's consumption preferences and consumption restrictions.

14. The method of claim 1, further comprising removing a particular consumption option from the current consumption options for a predetermined time period in response to a particular user of a plurality of users being absent for the predetermined time period, the particular consumption option preferred by the particular user.

15. An apparatus comprising:
an inventory module for maintaining a consumables inventory by monitoring acquisition and consumption of a plurality of consumables;
a storage module for storing a plurality of consumption options, each consumption option specifying a use for one or more particular consumables of the plurality of consumables;
a production module for producing a plurality of current consumption options for consumption within a predetermined time period and for selecting a particular consumption option as a particular current consumption option based on a cost of consumables in the particular consumption option.

16. The apparatus of claim 15, further comprising an acquisition list module for generating an acquisition list identifying additional consumables for acquisition, the acquisition list based on one or more of consumption of the plurality of consumables and consumable requirements for the plurality of current consumable options.

17. The apparatus of claim 15, further comprising an assignment module for assigning a particular consumable to a particular consumable option and decrementing an amount of the particular consumable in the consumables inventory in response to the user consuming the particular consumable option.

18. The apparatus of claim 15, further comprising a leftover module for identifying a leftover consumable remaining from a consumption option and assigning an expiration date to the leftover consumable based on one or more predetermined factors.

19. A system comprising:
a processor;
a memory storing modules for execution by the processor, the memory comprising:
an inventory module for maintaining a consumables inventory by monitoring acquisition and consumption of a plurality of consumables;
a storage module for storing a plurality of consumption options, each consumption option specifying a use for one or more particular consumables of the plurality of consumables;
a production module for producing a plurality of current consumption options for consumption within a predetermined time period and for selecting a particular consumption option as a particular current consumption option based on a cost of consumables in the particular consumption option.

20. The system of claim 19, further comprising a scanner in communication with the processor, the scanner for scanning an identifier for a particular consumable of the plurality of consumables, the inventory module one of adding and removing the particular consumable from the consumables inventory in response to the scanner scanning the identifier.
